(19) United States
(12) Patent Application Publication
(10) Pub. No.: US 2013/0292571 A1
(43) Pub. Date: Nov. 7, 2013

(54) OPTICALLY MULTIPLEXED MID-INFRARED LASER SYSTEMS AND USES THEREOF

(71) Applicants: Anadi Mukherjee, Fremont, CA (US); Manu Prasanna, Los Altos Hills, CA (US); Nandini Mukherjee, Fremont, CA (US)

(72) Inventors: Anadi Mukherjee, Fremont, CA (US); Manu Prasanna, Los Altos Hills, CA (US); Nandini Mukherjee, Fremont, CA (US)

(73) Assignee: Infrasign, Inc., Fremont, CA (US)

(21) Appl. No.: 13/481,695

(22) Filed: May 25, 2012

Related U.S. Application Data
(60) Provisional application No. 61/492,614, filed on Jun. 2, 2011.

(51) Int. Cl. G01J 3/10

(52) U.S. Cl. CPC G01J 3/108
USPC 250/339.11

(57) ABSTRACT

Optically multiplexed mid-infrared laser systems and the use of such systems for detection and measurement of target materials using multispectral image analysis are disclosed. The systems and methods disclosed herein are useful for detecting and measuring materials in applications such as trace detection, medical diagnostics, medical monitoring, quality control, and high-throughput molecular recognition.

This application claims the benefit under 35 U.S.C. §119(e) of U.S. Provisional Application No. 61/492,614 filed on Jun. 2, 2011, which is incorporated by reference herein in its entirety.

Disclosed herein are optically multiplexed mid-infrared laser systems and the use of such systems for detection and measurement of materials on surfaces using multispectral image analysis. The systems and methods disclosed herein are useful for detecting and measuring target materials in applications including trace detection, medical diagnostics, quality control, molecular recognition.

### BACKGROUND

Hyperspectral image-based molecular analysis with high throughput, high sensitivity, and high specificity has many applications in fields such as civilian security, military surveillance, medical diagnostics, quality control, and molecular recognition.

The detection and measurement of materials on surfaces is of considerable importance for a variety of civilian security and military surveillance applications. Standoff measurement of trace materials such as explosives and hazardous materials on objects and surfaces at a safe distance remains a significant challenge. Since almost all compounds exhibit strong characteristic absorbance patterns in the mid-infrared spectral range, trace detection may be accomplished, for example, using highly sensitive and selective mid-IR multispectral imaging. Standoff detection using tunable quantum cascade lasers is disclosed, for example, by Bernacki and Phillips, Proceedings SPIE, 2010, 7665, 766501-1 to 7660501-10; Phillips and Hô, Optics Express 2008, 16(3), 1836-1845.

Infrared (IR) imaging is a highly sensitive technique that is useful for detecting chemicals on surfaces at standoff distances, i.e., greater than 1 meter. Methods that employ active illumination of a surface typically detect optical reflectance or a differential temperature change through the photothermal effect. Current infrared imaging methods employ a single tunable laser source to either scan a relevant region or regions of the IR spectrum or to irradiate a surface at selected IR wavelengths. For example, current methods of analyte detection using hyperspectral image analysis involve scanning an irradiation source through a spectral range, obtaining images at wavelength intervals over the scanned range, and analyzing the hyperspectral images based on a reference library image of an analyte of interest. While the amount of information provided by scanning methods has been demonstrated to enable the detection of small amounts of analyte on a surface, such methods can be time consuming, and difficult to achieve over broad spectral regions due to the limited tuning ranges of certain laser sources. In particular, scanning methods are not practical for continuous real-time monitoring applications. Furthermore, for certain analytes, hyperspectral images over a broad spectral range may provide greater selectivity and sensitivity; however, with greater complexity and increased scanning times.

Mid-IR spectroscopy is also widely used in medicine. In certain medical applications, biomolecules or biomarkers may be detected in body fluids and/or tissue for monitoring or diagnosing a disease, or for clinical analysis. Low-Ying et al., Vibrational Spectroscopy 2002, 28, 111-116; Wolf et al., U.S. Pat. No. 7,524,681; Garidel and Boese, Microscopy Research and Technique 2007, 70, 336-3491; Ahmed et al., Vibrational Spectroscopy 2010, 53(2), 181-188; Jackson et al., Biophysical Chemistry 1997, 68, 109-125. In surgical applications mid-IR spectroscopy has been shown to be useful in distinguishing diseased from non-diseased tissue. Amharref et al., Biochimica et Biophysica Acta 2006, 1758, 892-899; Sobottka et al., Anal Bioanal Chem 2009, 393, 187-195. Applications involve using in vivo imaging and in vitro imaging of fluids and/or tissue. In many medical applications, mid-IR spectroscopy methods that can provide rapid, sensitive, and selective analysis of biomarkers and biomolecules are needed. Such methods can find application in the burgeoning field of personalized medicine.

Another application of mid-IR spectroscopy is in quality control and quality analysis. Gowen et al., Eur. J Pharmacetuics and Biopharmaceutics 2008, 69, 10-22; Reich, Advanced Drug Delivery Reviews 2005, 57, 1109-1143. Real-time mid-IR analysis has applications in areas such as pharmaceutical manufacturing, chemical manufacturing, and food processing.

Mid-IR spectroscopy can also be useful in applications requiring high-throughput molecular recognition such as in high-throughput screening assays used in molecular biology and in drug discovery.

Thus, there is a need for mid-IR spectroscopic platforms for use in real-time multispectral image analysis in a wide-range of applications.

### SUMMARY

As disclosed herein, by judiciously selecting two or more characteristic wavelengths that are sufficient to identify an analyte with the requisite sensitivity and selectivity the imaging system and sample analysis can be greatly simplified. Multiple radiation sources emitting at specific predetermined central wavelengths can provide the requisite hyperspectral images, thereby avoiding the complexity of scanned systems, which include, for example, redundant images, limited tuning ranges, and complex scanning optics

The speed of analysis may be improved by using multiple mid-IR lasers, each tuned to a wavelength that enables the detection and measurement of one or more target materials. The multiple lasers may be multiplexed to irradiate an area of a surface and to provide multispectral images of the irradiated area at each of the wavelengths. The multispectral images may then be analyzed to extract information about target materials from non-target materials.

In a first aspect, a system for imaging an area with radiation at a plurality of mid-infrared wavelengths is disclosed, comprising:

a plurality of lasers, wherein each of the plurality of lasers emits radiation having a unique central wavelength from 2 μm to 20 μm;

an optical multiplexer for independently selecting the radiation emitted by the plurality of lasers;

a controller operably connected to the optical multiplexer for independently selecting the radiation;

optics for irradiating the area with the selected radiation; and

a detector for imaging the selected radiation reflected from the area.

In a second aspect, a method for imaging an area with radiation at a plurality of mid-infrared wavelengths is disclosed, comprising:

providing a plurality of lasers, wherein each of the plurality of lasers emits radiation having a unique central wavelength from 2 μm to 20 μm;

independently selecting the radiation from the plurality of lasers;

irradiating the area with the selected radiation; and

detecting the selected radiation reflected from the area to obtain images of the area.

In a third aspect, a method of quantifying an amount of an analyte on an area is disclosed, comprising:

irradiating the area of the surface with radiation emitted by a first laser having a first wavelength from 2 μm to 20 μm and corresponding to a vibrational mode of the analyte;

detecting the radiation emitted by the first laser that is reflected from the area;

irradiating the area with radiation emitted by a second laser having a second wavelength from 2 μm to 20 μm and that does not correspond to a vibrational mode of the analyte;

detecting the radiation emitted by the second laser that is reflected from the area; and

operating on the detected radiation emitted by the first laser and the detected radiation emitted by the second laser to quantify the amount of the analyte on the area.

In a fourth aspect, a method of quantifying an amount of each of a plurality of analytes on an area is disclosed, comprising:

independently irradiating the area with radiation emitted by a plurality of lasers, each of the plurality of lasers having a unique wavelength from 2 μm to 20 μm, wherein:
at least one of the wavelengths corresponds to a vibrational mode of each of the plurality of analytes; and
at least one of the wavelengths does not correspond to any vibrational mode of the plurality of analytes;

independently detecting the radiation emitted by each of the plurality of lasers that is reflected from the area; and

operating on the detected radiation to quantify the amount of each of the plurality of analytes on the area.

In a fifth aspect, sets of wavelengths for measuring an analyte of interest in a sample is disclosed, comprising:

a first wavelength at which the analyte exhibits absorption; and

a second wavelength at which the analyte exhibits less absorption than the absorption at the first wavelength;

wherein the first and second wavelengths are from 2 μm to 20 μm.

In a sixth aspect, devices for reducing laser speckle is disclosed, comprising a waveguide; wherein the waveguide is rotated or vibrated.

In a seventh aspect, methods for reducing laser speckle are disclosed, comprising passing laser radiation through a waveguide; and rotating or vibrating the waveguide.

In an eighth aspect, devices for multiplexing a plurality of light beams are disclosed, comprising at least two blazed gratings, wherein each of the light beams has a different central wavelength.

In a ninth aspect, methods for multiplexing a plurality of light beams are disclosed, comprising:

directing a first plurality of light beams onto a first blazed grating to provide a first scattered beam;

directing a second plurality of light beams onto a second blazed grating to provide a second scattered beam; and

combining the first scattered beam and the second scattered beam using a first dichroic beamsplitter.

### BRIEF DESCRIPTION OF THE DRAWINGS

Those skilled in the art will understand that the drawings, described herein, are for illustration purposes only. The drawings are not intended to limit the scope of the present disclosure.

FIG. 1 shows an example of an optical system in which multiple laser beams are multiplexed using an electronically angle-tuned mirror.

FIG. 2 shows an example of combining multiple laser beams using a blazed grating.

FIG. 3 shows an example of combining multiple laser beams using two blazed gratings.

FIG. 4 shows an example of combing multiple laser beams using three blazed gratings.

FIG. 5 shows an example of combining three blazed gratings and dispersion compensating optics combining radiation from multiple mid-IR laser with discrete wavelengths from 2 μm to 19 um.

FIG. 6 shows a rotating hollow waveguide with diffuse internal reflection for use in despeckling laser radiation.

FIG. 7 shows FTIR absorption spectra of β-RDX and α-RDX on a stainless steel surface.

FIG. 8 shows FTIR absorption spectra of TNT and silicone rubber.

FIG. 9 shows FTIR reflectance spectra of NH₃NO₄ powder at different temperatures.

FIG. 10 shows FTIR spectra of (A) nylon, (B) automotive side-panel polymer, (C) automotive taillight polymer, and (D) polystyrene, respectively.

FIG. 11 shows the FTIR reflectance spectrum of kaolin and the reflectance of kaolin following at 2.5 μm and at 2.7 μm.

FIG. 12 shows FTIR absorption spectra of blood from about 1000 cm⁻¹ to about 4000 cm⁻¹.

FIG. 13 shows FTIR absorption spectra of dried films of LDL, HDL, and blood serum from about 1000 cm⁻¹ to about 4000 cm⁻¹.

FIG. 14 shows an illustration of a surgical device incorporating a multiplexed laser system provided by the present disclosure.

FIG. 15 shows FTIR absorption spectra of healthy brain and glioma tissue sections in the spectral region (A) 750 cm⁻¹ to 1900 cm⁻¹, and (B) 2500 cm⁻¹ to 3800 cm⁻¹.

FIG. 16 shows simulated data for characterizing gliomas.

FIG. 17 is a composite showing the an embodiment of an intraoperative surgical tool incorporating a multiplexed laser system provided by the present disclosure, a visible image of a cross-section of a brain, IR spectroscopic images associated with astrocytoma II, glioblastoma, and normal brain tissue, and simulated data for identifying gliomas.

FIG. 18 shows (A) FTIR absorbance spectra of normal and basalioma tissue, and (B) FTIR spectra of normal and epithelioma tissue.

FIG. 19 shows FTIR absorbance spectra of human hp8 (PKAhp8) and phosphorylated hp8.

FIG. 20 shows FTIR absorbance spectra of different configurations of fibrillary aggregates of the α-synuclein protein in the cytoplasm.

FIG. 21 shows simulated FTIR absorbance data and system demonstrating use of systems provided by the present disclosure of use in microarray analysis.

FIG. 22 shows an example of an experimental arrangement for use of systems provided by the present disclosure in high-throughput drug-target screening.

FIG. 23 shows a schematic for using optical systems provided by the present disclosure for use in measuring time-resolved affinity and kinetics in a protein microchip array.

### DETAILED DESCRIPTION

In certain embodiments, optical systems provided by the present disclosure for imaging an area with radiation at a plurality of mid-infrared wavelengths, comprise: a plurality of lasers, wherein each of the plurality of lasers emits radiation having a unique central wavelength from 2 μm to 20 μm; an optical multiplexer for independently selecting the radiation emitted by the plurality of lasers; a controller operably connected to the optical multiplexer for independently selecting the radiation; optics for irradiating the area with the selected radiation; and a detector for imaging the selected radiation reflected from the area.

In certain embodiments, the selected radiation comprises: radiation from a first laser with a central wavelength corresponding to a vibrational mode of an analyte; and radiation from a second laser with a central wavelength that does not correspond to a vibrational mode of the analyte.

In certain embodiments, the selected radiation comprises: radiation from a first laser having a first central wavelength; and radiation from a second laser having a second central wavelength; wherein the first central wavelength and the second central wavelength are selected to identify the presence of an analyte of interest on the area.

In certain embodiments, the selected radiation includes radiation having a wavelength corresponding to at least one vibrational mode a single analyte of interest.

In certain embodiments, the selected radiation includes radiation having a central wavelength corresponding to at least one vibrational mode of more than one analyte of interest.

In certain embodiments, at least one of the plurality of lasers emits radiation with a central wavelength corresponding to a vibrational mode of an analyte of interest.

In certain embodiments, the plurality of lasers emits radiation with central wavelengths corresponding to vibrational modes of a plurality of analytes of interest.

Optical systems disclosed herein may use any mid-IR laser source, e.g., 2 μm to 20 μm.

In certain embodiments, a system comprises a plurality of mid-IR lasers, for example, from 2 to 5 lasers, from 5 to 10 lasers, from 10 to 20 lasers, and in certain embodiments, more than 20 lasers. In certain embodiments, each of the plurality of lasers emits a different central wavelength in the mid-IR.

In certain embodiments, the mid-IR lasers are selected from quantum cascade lasers (QCL), interband cavity lasers (ICL), and combinations thereof. Any type of QCL or ICL may be used. In certain embodiments, tunable external cavity quantum cascade lasers that may be tuned to a particular wavelength within their tuning range may be used.

For a particular application, each of the plurality of lasers operates at a particular wavelength, and is not operated in a scanned mode. As a consequence, the breadth of the tuning range of a laser is not particularly important. Rather, it is desirable that when tuned to a particular central wavelength, that the central wavelength is maintained. Thus, the lasers may be fabricated to have narrow tuning ranges or may be fabricated to emit a single, predetermined wavelength.

In certain embodiments, each or the plurality of lasers provides radiation at a specific central wavelength. In certain embodiments, the lasers are tunable over a certain range, and are tuned to provide radiation at a specific wavelength within the range. In certain embodiments, the lasers are fabricated to provide radiation at only a single wavelength.

In certain embodiments, a laser provides an average output power from about 2 mW to about 100 mW, from about 2 mW to about 250 mW, from about 2 mW to about 500 mW, from about 2 mW to about 1 W, from about 0.5 W to about 2 W, from about 0.5 W to about 5 W, from about 0.5 W to about 10 W, from about 1 W to about 20 W, from about 2 mW to about 20 W, and in certain embodiments, greater than about 20 W.

The lasers may be operated in the continuous wave (CW) or pulsed modes. The lasers may be independent units or may be integrated into a monolithic device. As independent units, the lasers may include, for example, separate power supplies, thermal management systems, tuning systems, and wavelength stabilization mechanisms. As an integrated device, certain aspects such as the power supply and thermal management systems may be shared by more than one of the lasers. For example, in certain embodiments, the plurality of lasers may be mounted on a single thermoelectric cooling device.

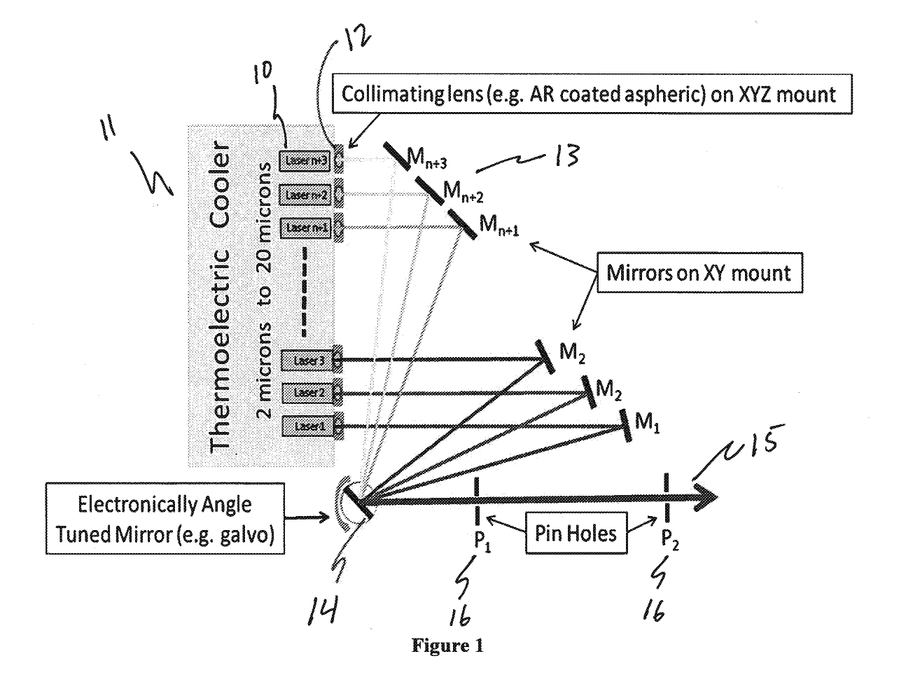

The output radiation of the lasers is directed to collinearly illuminate an imaging area. The optics used to direct the laser radiation onto the imaging area may differ depending on whether the lasers are operated in the CW or pulsed modes. Examples of optical systems appropriate for CW laser operation are shown in FIGS. 1, 2, and 3. Generally, in such optical systems, the output of each of the lasers is directed into a collinear beam impinging on an imaging area. As shown in FIGS. 1, 2, and 3, this may be accomplished, for example, using mirrors, gratings, or waveguides. Lenses may be used at appropriate locations to focus, collimate, and/or direct the radiation from the plurality of lasers using methods known in the art as appropriate. Wavelength selection for irradiation and/or detection may be accomplished by adjusting one or more of the optical elements to direct the radiation incident on and/or reflected from the imaging area.

In a system incorporating pulsed lasers, similar optics may be employed as in CW laser systems except that adjustable optics are not necessarily used for wavelength selection. For pulsed laser systems, wavelength selection may be accomplished by independently activating individual lasers.

In referring to the wavelength of laser radiation it is to be understood that the radiation is characterized by a generally Gaussian profile having a maximum central wavelength and full width at half maximum (FWHM) or bandwidth. For QCL lasers, typical bandwidths range from about 25 cm⁻¹ as in Fabry-Perot QCLs to about 10⁻⁴ cm⁻¹ as in external cavity QCLs.

Multi-aperture beam combining techniques that produce composite beams with high beam quality are known in the art. Multi-aperture beam combining techniques that produce composite beams with high beam quality may be divided into two broad classes. Coherent beam combining involves phase locking individual emitters to each other or a common master oscillator. Fan, IEEE J Quantum Electron, 2005, 11(3), 567-577. Spectral beam combining (SBC) exploits the broad gain bandwidth of fiber and semiconductor lasers by combining different sources into a single output beam. A dispersive beam-combining element, such as a diffraction grating, may be used to overlap the radiation from multiple, spectrally distinct lasers into a single beam. The approach has been successfully applied to diode lasers. Spectral combining elements include dielectric filters, volume Bragg gratings, and planar diffraction gratings. A dual grating approach for spectral beam combining the output of multiple fiber lasers with 83% efficiency is described by Madasamy et al., IEEE J. Selected Topics Quantum Electronics, 2009, 15(2), 337-343. Any optical multiplexing system known in the art may be employed in optical systems provided by the present disclosure.

Optical multiplexing using a scanning galvanometer is described by Mukherjee et al., Applied Optics, 2008, 47(27), 4884-4887, Patel et al., U.S. Publication No. 2009/0116518, and Takada, US 2002/0027932. In the optical multiplexer described by Mukherjee et al., the output of each of the individual lasers impinges on a focusing mirror that directs the radiation to the same axis point of a rotatable mirror. As the mirror rotates, the radiation from each of the lasers is brought into alignment with an iris collimator that separates out all the non-selected radiation, while transmitting the alighted wavelength. Because the radiation from each of the lasers is continuously available, radiation from a selected laser may be brought into alignment by tuning the mirror by tuning the mirror.

A diagram of an embodiment of a spatially multiplexed system using an electronically angle-tuned mirror is shown in FIG. 1. Multiple mid-IR lasers 10 are mounted on a substrate 11. The output of each laser is collimated with lens 12 and directed onto separate adjustable mirrors 13. The output of each laser 10 is coplanar. Adjustable mirrors 13 may be fixed or may be adjustable to accommodate alignment changes during use. Adjustable mirrors 13 direct the laser radiation onto a coincident axis point on rotatable mirror 14. Radiation from each of the lasers impinges on rotatable mirror 14 at a unique angle of incidence. Rotatable mirror 14 can be pivoted about its vertical axis to direct the laser radiation from a particular adjustable mirror 13 to imaging optics (not shown). Collimating optics 12, adjustable mirror 13 and rotatable mirror 14 align the radiation from each laser 10 to define a collinear output beam 15, which when expanded, images an area of a surface (not shown). Depending on the angle of rotatable mirror 14, the radiation from a particular laser 10 forms output beam 15. In certain embodiments, output beam 15 passes through one or more apertures 16. The one or more apertures 16 can be useful for minimizing or preventing non-selected radiation from contributing to output beam 15.

Upon switching to a new laser, the mirror may be held for at least about the time required to record a single image frame, before switching to another laser. Images acquired by along wavelength IR (LWIR) camera such as a microbolometer or cooled mercury cadmium telluride (MCT) focal place array (FPA) may be synchronized with the operation of the lasers. In certain embodiments, the switching time between lasers can be synchronous to the camera off time (time between frames recorded by the camera). In certain embodiments, the pulsed operation of the lasers and the camera may be electronically synchronized, for example the synchronous trigger signal from the camera can be used to synchronize at least one image frame recording with one particular laser wavelength being on during the recording of the image frame(s). The recorded hyperspectral images will correspond to images obtained at particular laser wavelengths.

Angular tuning of mirror 14 may be provided by a DC servo-motor-driven rotation stage. The galvanometer may be controlled to within ±0.5° C. With capacitive position feedback the repeatability of the angular position is within 10 μrad. The galvanometer may be optimized for position accuracy and not for speed, with typical switching times of about 500 μsec. With a maximum scan angle of the optical beam of ±50 degrees, scanning over an angle of 100 degrees is possible, thereby enabling the multiplexing of a large number of lasers. Because the throughput of the non-dispersive elements comprising the multiplexer is limited by only two reflections, the multiplexer can achieve throughput efficiency greater than about 98%, and in certain embodiments, greater than about 99%.

When mid-IR lasers 10 are operating in a continuous mode, the output of individual lasers may be selected by rotating mirror 14. In certain embodiments, the laser output may be selected at the rate of at least about 3 Hz, at least about 30 Hz, and in certain embodiments, at least about 300 Hz.

Alternatively, throughput efficiencies greater that 99% may be achieved and problems associated with mechanical vibration of multiple diffractive elements can be reduced by using one or more blazed gratings for optical multiplexing. The use of blazed gratings for spectral beam combining is described by Brown et al., U.S. Pat. No. 7,199,924. In these systems, chromatic dispersion is compensated for by diffraction of laser radiation from two gratings or double diffraction from a single high-efficiency dielectric diffraction grating. At the Littrow condition blazed gratings function as mirrors with reduced chromatic dispersion. The Littrow condition in blazed gratings can be efficiently used for beam combining. Over 90% of the power of an incident beam can be diffracted. Using the blazed condition characteristics for an s-polarized beam at a wavelength in the middle of a range of interest a large number of monochromatic beams at different wavelengths may be combined. For example, Loewen et al., Applied Optics, 1977, 16(10), 2711-2721 demonstrate the high efficiency of triangular groove blazed gratings over a wide range of λ/d values.

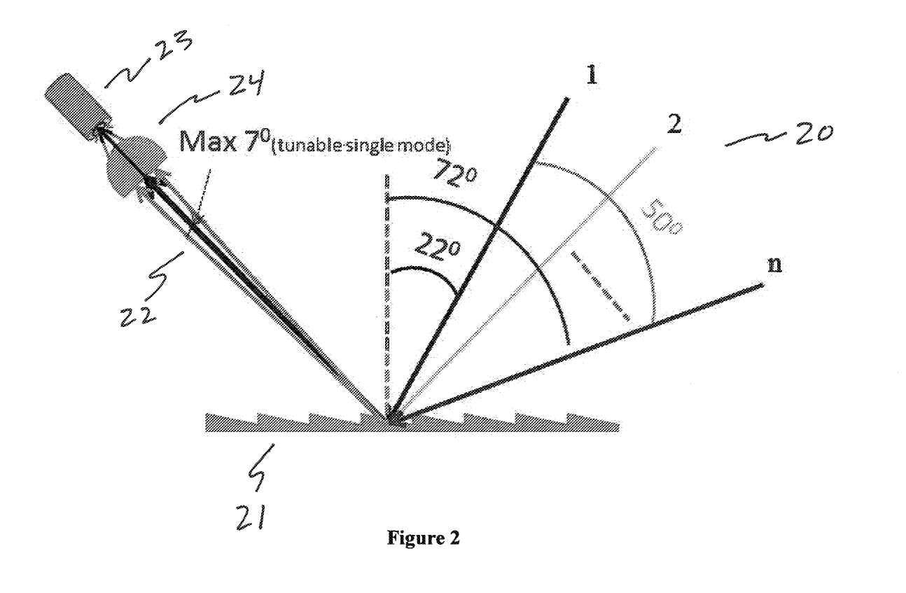

Combining beams of different wavelengths using a blazed grating is illustrated in FIG. 2. As shown in FIG. 2, laser beams (1−n) 20 of different wavelengths are incident on blazed grating 21 over a 50° angle and are combined into a single output beam 22 as the beams of different wavelength are diffracted at different angles according to the blazed condition 2d sin θ=λ. Simulated parameters (wavelength range and angular range for greater than 90% diffraction efficiency) for s-polarized radiation and average wavelength at which the blazed grating is optimized can be calculated for the range giving greater than 90% efficiency at the first order Littrow diffraction angles from 22° to 72°, i.e., λ/d=0.75 to 1.9 according the blazed condition 2d sin θ=λ.

For tunable external cavity single mode and Fabry-Perot QCLs and ICLs it is necessary to also consider the spectral bandwidth and its effect on beam coupling. The beam coupling walk-off due to spectral bandwidth can be calculated from 2d cos Δθ=Δλ, where Δθ is the angular spread of blaze condition for a spectral width Δλ. The Δθ values corresponding to the different mid-wavelengths, θₘᵢₙ (22°) and θₘₐₓ (72°) for a single-mode tuning range or Fabry-Perot bandwidth of a typical value of 200 nm can be estimated from 2d cos Δθ=Δλ.

Table 1 shows that it is possible to combine beams having a wavelength from 2 μm to 19 μm using three blazed gratings, with the output of each of the blazed gratings combined using dichroic beamsplitter to produce the final output beam to provide a single collinear output beam. FIG. 2 shows that the dispersion of the multiple laser beams of different wavelengths diffracted from a blazed grating can be compensated for using appropriate optics such as using a single mode fiber 23 and a hemispherical lens 24.

TABLE 1

| | | | | Δ θ | | | Δθ |
|---|---|---|---|---|---|---|---|
| | | | | (at θₘᵢₙ | | | (at θₘₐₓ |
| Mid- | | | | in degrees | | | in degrees |
| Wavelength | d | λₘᵢₙ | θₘᵢₙ | for FP or | λₘₐₓ | θₘₐₓ | for FP or |
| (um) | (μm) | (μm) | (rad) | EC-lasers) | (μm) | (rad) | EC-lasers) |
| 3.5 | 2.6 | 2.1 | 0.42 | 2.4 | 5.0 | 1.2 | 7.0 |
| 7 | 5.3 | 4.3 | 0.42 | 1.2 | 10.0 | 1.2 | 3.5 |
| 13 | 9.8 | 8.0 | 0.42 | 0.6 | 18.7 | 1.2 | 1.9 |

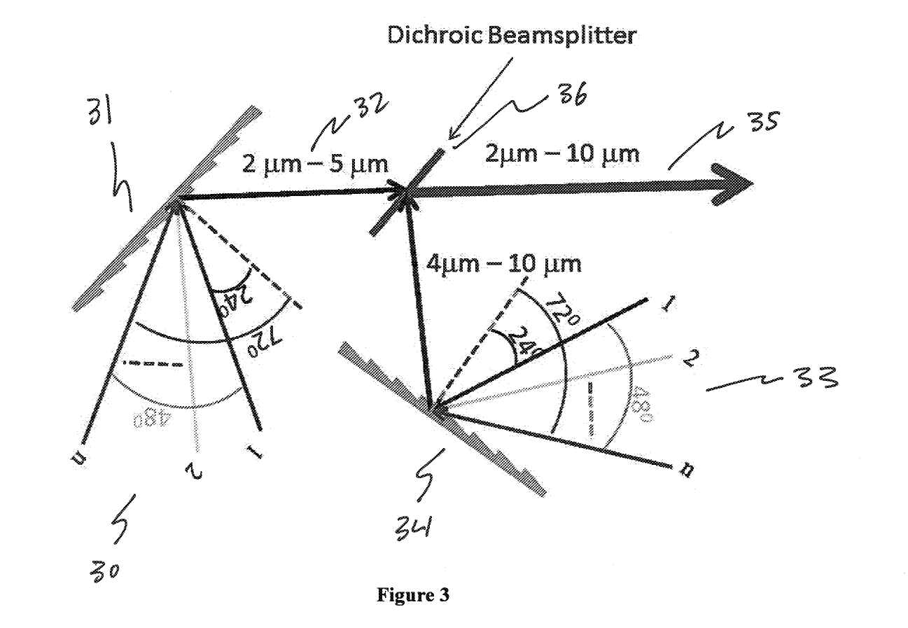

To accommodate multiple lasers with radiation spanning 2 μm to 20 μm, an optical system incorporating multiple blazed gratings may be used. For example, a two-stage system incorporating two blazed gratings for combining radiation in the range of 2 μm to 4.9 μm and 4.1 μm to 9.8 μm may be used to span from 2 μm to 10 μm range via passive beam combining. In the optical multiplexer illustrated in FIG. 3, radiation from multiple lasers 30 with wavelengths from 2 μm to 4.9 μm impinges on a first blazed grating 31 optimized for diffraction at 3.5 μm. Radiation 30 is diffracted by first blazed grating 31 to provide a first output beam 32. Radiation from multiple lasers 33 with wavelengths from 4.1 μm to 9.8 μm impinges on a second blazed grating 34 optimized for diffraction at 7.0 μm to form a second output beam 35. First output beam 32 and second output beam 35 may be combined using, for example, a dichroic beamsplitter 36.

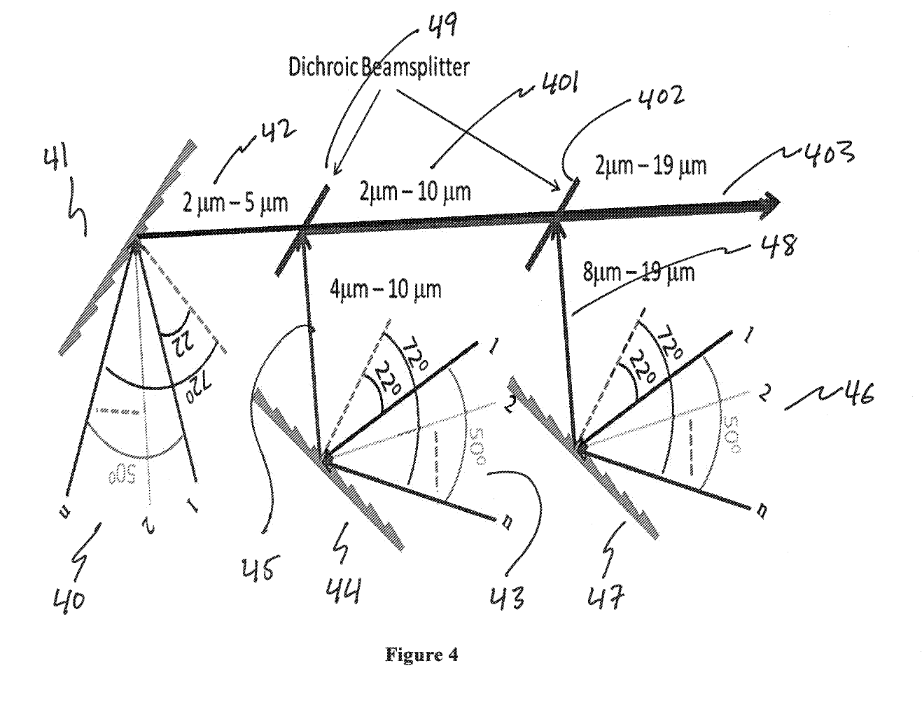

FIG. 4 shows a system in which three blazed gratings are used to combine laser beams having wavelengths from 2 μm to 19 μm. Radiation having wavelengths from 2 μm to 5 μm 40 are coincident on a first blazed grating 41 optimized for diffraction at 3.5 μm and are combined into a first diffracted beam 42. Radiation having wavelengths from 4 μm to 10 μm 43 are coincident on a second blazed grating 44 optimized for diffraction at 7 μm and are combined into a second diffracted beam 45. Radiation having wavelengths from 8 μm to 19 μm 46 are coincident on a third blazed grating 47 optimized for diffraction at 13 μm and are combined into a third diffracted beam 48. First and second diffracted beams 42/45 are combined using first beam splitter 49, and the combined first and second beams 401 are combined with third diffracted beam 48 using a second beam splitter 402 to provide collinear output beam 403.

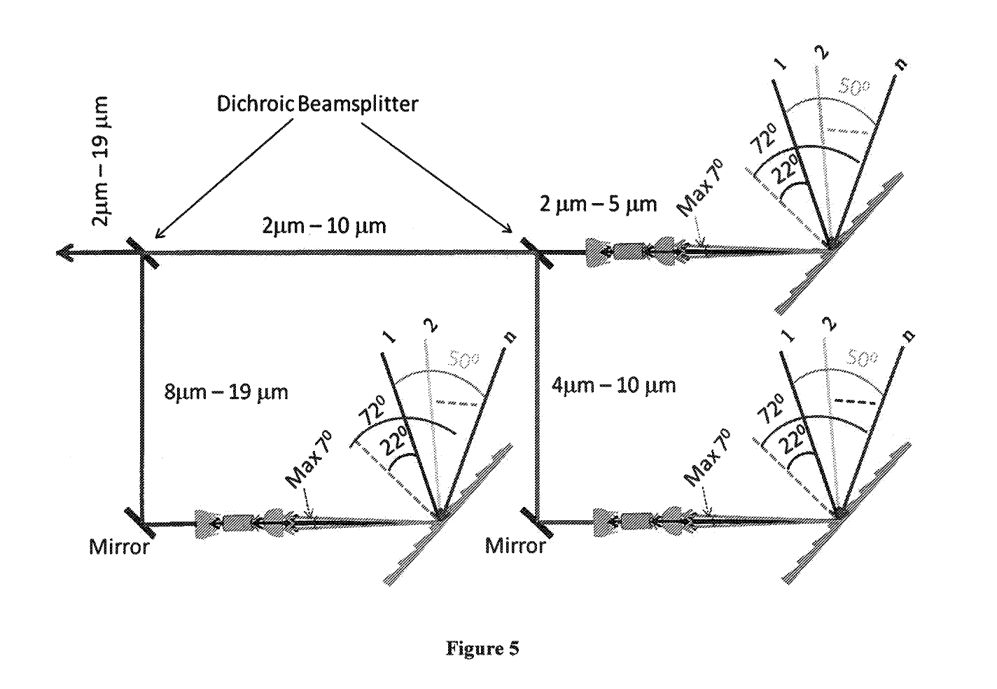

FIG. 5 shows a system in which three blazed gratings and dispersion-compensating optics are used to combine radiation from a plurality of mid-IR lasers with discrete wavelengths from 2 μm to 19 μm into a single collinear output beam. Dispersion compensating optics includes optics for focusing the beams diffracted from the blazed grating into an optical waveguide and optics for collimating the beams exiting the waveguide. In certain embodiments, the optical waveguide may be an optical fiber such as a single mode optical fiber. At each stage, the beams diffracted from a blazed grating are compensated for wavelength dispersion to provide a collinear output beam. Combining the diffracted beams from three blazed gratings into a single waveguide may also be accomplished using branched or fused IR transmitting waveguides.

In certain embodiments, the angle-tuned mirror 14, of FIG. 1, may be replaced with a blazed grating.

In systems using blazed gratings, radiation from a particular laser can be selected by powering each laser individually.

The appropriate selection of optical multiplexer will at least in part be determined by whether the lasers are operated in a CW or pulsed mode. For example, the spatial optical multiplexer using a tunable mirror as shown in FIG. 1, may be used with either CW or pulsed laser sources. Blazed gratings, as shown for example in FIG. 2 and FIG. 3, may be appropriate for use with both CW and pulsed laser sources.

To achieve high spatial resolution and scattering efficiency, particularly for standoff detection at steep viewing angles and long standoff distances it can be desirable to reduce laser speckle.

An issue in active imaging with coherent illumination is the formation of speckles caused by interference effects of the coherent laser radiation. Voronin et al., Sov. J. Quant. Elec., 1974, 3(4), 351. The coherent interference is induced by the surface roughness of the illuminated object. Without a means for reducing of the speckle the spatial root-mean-squared (RMS) noise can reach values exceeding 50%, completely obscuring any spectral signature caused by small traces of analytes. Various methods for reducing speckle are known in the art. Goodman, “Speckle phenomena in Optics: Theory and Applications,” Roberts and Co. Publishers, 2007. Use of a rotating diamond diffuser to reduce speckle is disclosed by Hinkov et al., Proc. SPIE, 2009, 7484, 748406-1 to 74806-13. However, rotating diamond diffusers are only useful for imaging at low laser power. Any method and/or device known in the art for reducing laser speckle may be used in the optical systems disclosed herein.

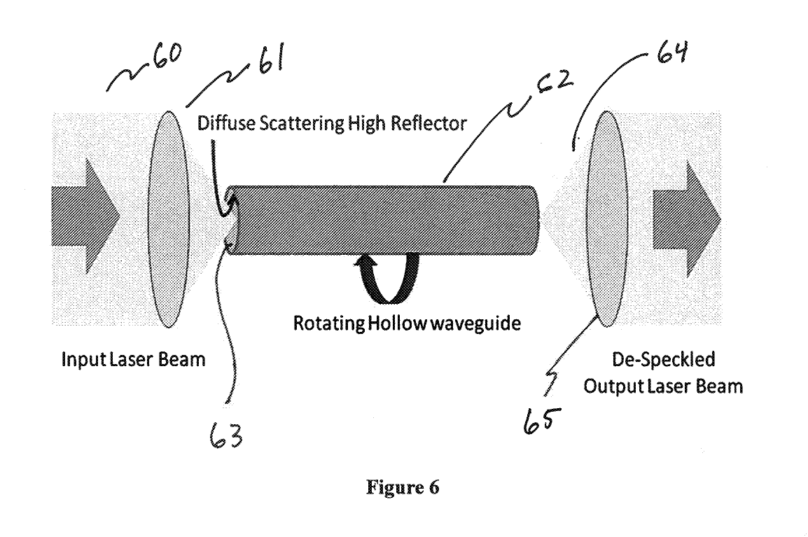

An example of a device for despeckling laser radiation is shown in FIG. 6. As shown in FIG. 6, laser radiation 60 is directed by optic 61 into a rotating hollow waveguide 62. Mid-IR transmitting hollow waveguides are disclosed, for example, by Harrington, Fiber and Integrated Optics, 2000, 19(3), 211-227. The inner surface 63 of the hollow waveguide 62 includes a mid-IR reflective coating and is roughened to provide diffuse reflection. The inner surface of the waveguide may be roughened, for example, by chemical or reactive ion etching. Inner surface 63 of waveguide 62 may be coated with a metal or dichroic material to provide the mid-IR reflective coating. The radiation 64 exiting rotating hollow waveguide 62 is formed into a collimated beam by optics 65. Hollow waveguide 62 may be rotated and/or the input end may be vibrated at random to reduce laser speckle.

In certain embodiments, the inner diameter of the waveguide is from 10 μm to 1,000 μm, from 200 μm to 800 μm, from 300 μm to 700 μm, from 400 μm to 600 μm, and in certain embodiments, about 500 μm. In certain embodiments, the length of the waveguide is from 0.5 m to 2 m, from 0.75 m to 1.5 m, and in certain embodiments, about 1,000 m. In certain embodiments, the hollow waveguide may be rotated at a rate that is sufficient to reduce, minimize, or eliminate laser speckle. For example, in certain embodiments, the waveguide can be rotated, for example at least about 100 rpm, at least about 300 rpm, at least about 600 rpm, and in certain embodiments, at least about 1000 rpm. In certain embodiments, the hollow waveguide may be vibrated at, for example, at least about 10 Hz, at least about 20 Hz, at least about 50 Hz, at least about 100 Hz, and in certain embodiments, at least about 200 Hz. In certain embodiments, the waveguide may be both vibrated and rotated.

In certain embodiments, the despeckling device may comprise a solid waveguide of mid-IR transparent material and the outer surface of the solid waveguide is coated with a mid-IR reflective coating, which may be a dichroic coating, or a material having a lower refractive index. As outer surface of the solid waveguide may be roughened to provide diffuse internal reflection.

Imaging optics may be used to expand the output laser radiation from the optical multiplexer to image an area. The appropriate area will depend on the application. In certain embodiments for use in standoff detection, the imaged area can range from about 1 cm² to about 10 cm², from about 1 cm² to about 100 cm², from about 1 cm² to about 1000 cm², from about 1 cm² to about 1 m², and in certain embodiments, can be greater than about 1 m². For medical diagnostic applications, the multiplexed laser radiation may be coupled, for example, to the imaging optics of a microscope, endoscope, or surgical device. In these applications, the imaged area may be, for example, less than about 1 cm², less than about 0.1 cm², less than about 0.01 cm², and in certain embodiments, less than about 0.001 cm². In quality control applications, the imaged area may be, for example, less than about 100 m², less than about 10 cm², and in certain embodiments, less than about 1 cm². In high-throughput screening applications such as microarray imaging, the imaged area may be, for example, less than about 1 m², less than about 0.5 m², and in certain embodiments less than about 0.1 m². Imaging optics appropriate for each application may be employed as are known in the art.

Detection of the mid-IR laser radiation reflected from a surface may be accomplished using a high sensitivity image detector. In certain embodiments, detection is accomplished using a mid-IR camera such as a mercury-cadmium-telluride focal plane array or microbolometer. In certain embodiments the detector may be a pyroelectric detector. Detection may be synchronized to the irradiation of the area by the plurality of lasers such that each image represents the light reflected from the surface at a single frequency. Detection optics and methods are selected to provide the appropriate spatial and spectral resolution as appropriate for a particular application using devices and methods known in the art.

The output wavelength of each of the mid-infrared lasers may be uniquely selected to provide a selection of wavelengths to facilitate the detection, and in certain embodiments, quantification, of one or more materials on a surface. To accomplish this, wavelengths may be selected to correspond to one or more vibrational modes of each material of interest, one or wavelengths where one or more of the materials of interest do not exhibit appreciable absorption, and/or one or more wavelengths for which the surface shows characteristic absorption. A material of interest is also referred to herein as an analyte of interest.

These selected wavelengths, also referred to herein as an intelligent grid, may be established based on a library comprising a compilation of mid-infrared spectra for the materials of interest, materials not of interest but potentially present, for relevant surfaces, for the materials of interest on each of the relevant surfaces, and for materials not of interest but potentially present on each of the relevant surfaces. Mid-infrared spectra may be obtained for different concentrations of the materials of interest and the materials not of interest, particularly on the relevant surfaces.

Computational spectral analysis can provide the optimal selection of wavelengths.

In certain embodiments, for each material of interest a wavelength is selected corresponding to a vibrational mode of the material and a second wavelength is selected at which neither the material of interest nor any of the relevant surfaces exhibits appreciable absorption.

In certain embodiments, wavelengths are selected to enable the identification of the surface, following which an appropriate selection of wavelengths is made to identify/quantify a material of interest on the surface.

Wavelength selection may be determined based on a pre-established spectral library including analytes of interest, compounds not of interest, surfaces, and other compounds and materials expected to be encountered in a particular imaging application. Synthetic absorption/reflection spectra for various combinations and concentrations of the components are generated. Then, for a specific analyte of interest, the synthetic spectra are analyzed to determine two or more wavelengths which may be sued to qualitatively measure the analyte. In an illustrative example, one of the wavelengths may correspond to a mid-IR vibrational mode of an analyte and a second wavelength may correspond to a wavelength at which the analyte shows little if any absorption. However, in complex systems, comprising multiple contaminants and background materials, quantitative measurement of a particular analyte may be more appropriately accomplished at wavelengths other than those corresponding to absorption maxima or minima. In complex systems, sensitivity and selectivity of detection must also be considered. Sensitivity refers to the ability to quantitatively measure small amounts of an analyte of interest. Selectivity refers to the ability to distinguish an analyte of interest from other components making up the sample. To obtain a desired level of sensitivity, and selectivity, more than one wavelength reflecting the absorption of the analyte of interest and/or more than one wavelength reflecting the background absorption may be employed.

In certain embodiments, wavelengths may be selected to characterize the surface of the sample. For example, the type of luggage or type of terrestrial surface. The identification of the surface on which an analyte of interest is present may be used to facilitate measurement of the analyte. Examples of luggage surfaces include leather, plastic, aluminum, steel, fabric, and a combination of any of the foregoing. Examples of terrestrial surfaces include soil, sand, asphalt, concrete, gravel, rock, and a combination of any of the foregoing.

In certain embodiments, the selected wavelengths (or intelligent grid) comprise a set of wavelengths for measuring an analyte of interest on a surface, comprising: a first wavelength at which the analyte exhibits absorption; and a second wavelength at which the analyte exhibits less absorption than the absorption at the first wavelength; wherein the first and second wavelengths are from 2 μm to 20 μm.

In certain embodiments, the selected wavelengths comprise a set of wavelengths of claim 35, wherein the first wavelength corresponds to a vibrational mode of the analyte.

In certain embodiments, the second wavelength is a wavelength at which the analyte does not absorb.

In certain embodiments, the second wavelength is a wavelength at which the absorption of the analyte and the absorption of the surface are low with respect to the absorption of the analyte and the absorption of the surface at other wavelengths from 2 μm to 20 μm.

In certain embodiments, the second wavelength is a wavelength at which the absorption of the analyte and the absorption of the surface are minimal with respect to the absorption of the analyte and the absorption of the surface at other wavelengths from 2 μm to 20 μm.

In certain embodiments, the selected wavelengths comprise a set of wavelengths for measuring a plurality of analytes of interest on a surface, comprising: a plurality of first wavelengths, wherein each of the plurality of wavelengths corresponds to a wavelength at which at least one of the plurality of analytes exhibits absorption; and a plurality of second wavelengths, wherein each of the plurality of wavelengths corresponds to a wavelength at which at least one of the analytes exhibits less absorption than the absorption at the first wavelength; wherein the plurality of first and second wavelengths are from 2 μm to 20 μm.

In certain embodiments, the selected wavelengths comprise a plurality of third wavelengths, wherein the plurality of third wavelengths represent characteristic absorption features of the surface and are from 2 μm to 20 μm.

The library comprises Fourier-transform infrared red (FTIR) absorbance and reflectance spectra from 2 μm to 20 μm for materials of interest, materials not of interest such as, for example, contaminants, dirt, oils, and solvents; particulates such as dust, soot, and pollutants; and surfaces such as, for example, fabrics, plastics, polymers, leather, metals, wood, composites, ceramics, paints, coatings, finishes, soil, sand, asphalt, concrete, and wood. The library of FTIR spectra may further include FTIR absorbance and reflectance spectra from 2 μm to 20 μm of different amounts or concentrations of materials of interest on each of the surfaces of interest. The spectra may include different amounts or concentrations of materials of interest deposited on a surface in a different manner. For example, the spectra may include a material of interest deposited onto a surface as a powder, particulate, suspension, solution, or imprint. The spectra may also include different amounts or concentrations of materials not of interest. The library may also comprise FTIR absorbance and reflectance spectra of any of the above at different temperatures, such as from about 0° C. to about 100° C., from about 10° C. to about 50° C., from about 15° C. to about 40° C., and from about 20° C. to about 30° C.

Using the library of FTIR absorbance and/or reflectance spectra synthetic FTIR spectra may be generated for different materials of interest at different concentrations, and materials not of interest at different concentrations, on different surfaces. By analyzing these spectra, a subset of wavelengths may be selected to facilitate the measurement of one or more materials of interest on any surface with a high level of sensitivity and selectivity.

Similar methods may be used to identify wavelengths for the detection of multiple materials of interest. A subset of the plurality of wavelengths will be appropriate for detecting a particular material of interest. Certain wavelengths may be unique for detecting an analyte of interest or may be useful for measuring more than one analyte of interest.

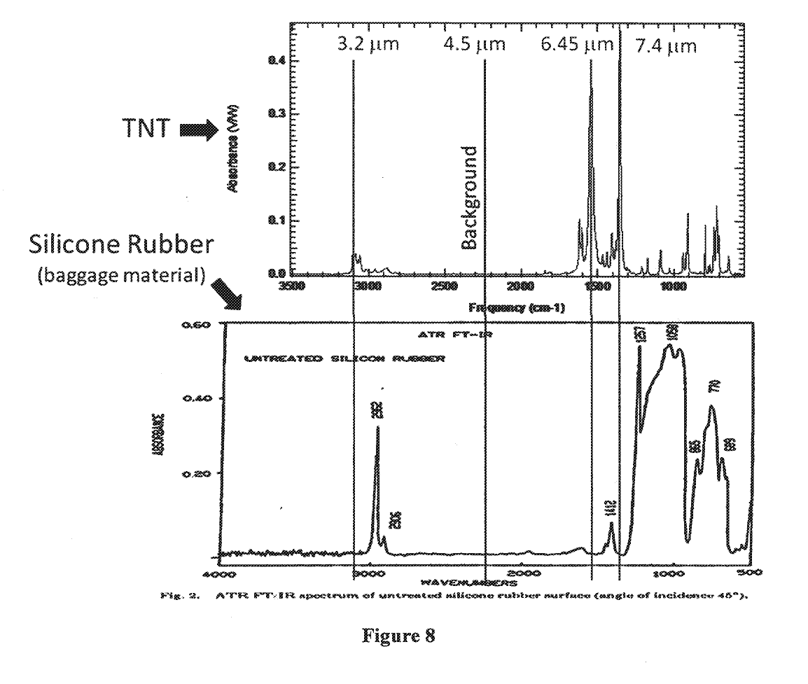

Selection of appropriate wavelengths for the measurement of RDX on a stainless steel surface may be demonstrated by reference to FIG. 7. FIG. 7 shows the FTIR absorption spectra for the α- and β-polymorphs of RDX. Superimposed on the spectra are vertical lines representing laser radiation from lasers QCL1, QCL2, QCL3, and QCL4 having unique wavenumbers of about 850 cm⁻¹, 1250 cm⁻¹, 1550 cm⁻¹, and 1850 cm⁻¹, respectively. The radiation from QCL1, QCL2, and QCL3 correspond to strong vibrational modes of α-RDX and β-RDX, while the radiation from QCL4 is not absorbed by either polymorph and represents the background absorption from the stainless steel surface. In this simple system, the measurement of RDX on a stainless steel surface may be determined by illuminating the surface with QCL1, QCL2, and/or QCL3 and determining the reflectance at each of the wavelengths, and illuminating the surface with QCL4 and determining the reflectance. The amount of RDX on the stainless steel surface may then be determined by analyzing, for example, the difference in the reflectance. In this way, the amount of RDX on a stainless steel surface may be determined using radiation at a subset of selected wavelengths. It can be appreciated that selection of other wavelengths may be used to distinguish between the two polymorphs of RDX.

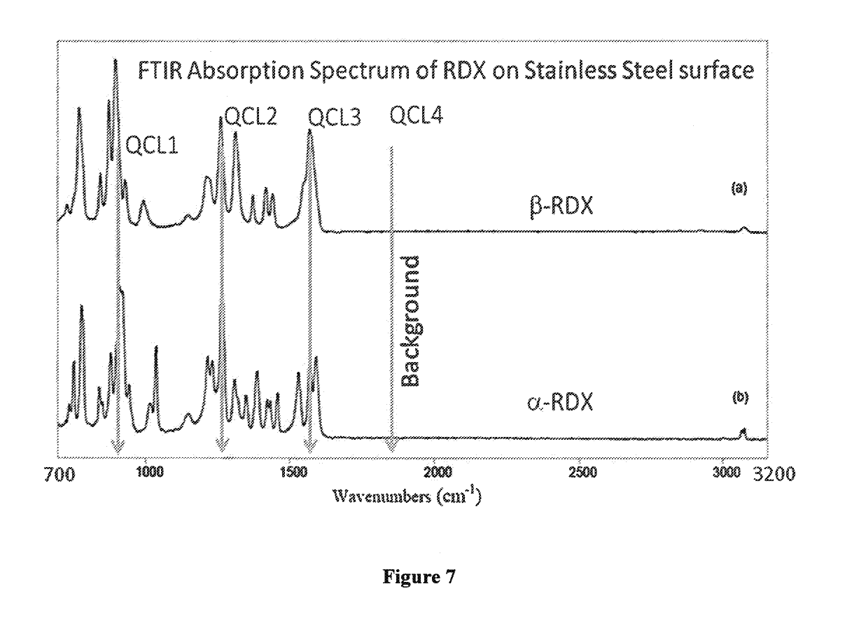

Similar methods to those describe for the measurement of RDX on a stainless steel surface may be employed to measure other materials on other surfaces. For example, FIG. 8 shows the FTIR absorbance spectrum for TNT and the FTIR absorbance spectrum for silicone rubber as an example of a baggage material. By comparing the two spectra, it can be appreciated that TNT exhibits characteristic absorption at certain frequencies at which silicone rubber exhibits little absorption. For example, TNT exhibits strong absorption at 3.2 μm, 6.45 μm, and 7.4 μm, whereas silicone rubber exhibits little if any absorption at the same frequencies. Thus, irradiation at 3.2 μm, 6.45 μm, and/or 7.4 μm could be used to measure TNT on a silicone rubber surface. Similarly, irradiation at a frequency of 4.5 um at which both TNT and silicone rubber does not show appreciable absorption could be used to establish a background measurement. Furthermore, one or more of the characteristic absorption features of silicone rubber could be used to establish the identity of the surface from among other surfaces. For example, irradiation at 2962 cm⁻¹, 1058 cm⁻¹, and/or 770 cm⁻¹ could be used to establish the identity of silicone rubber.

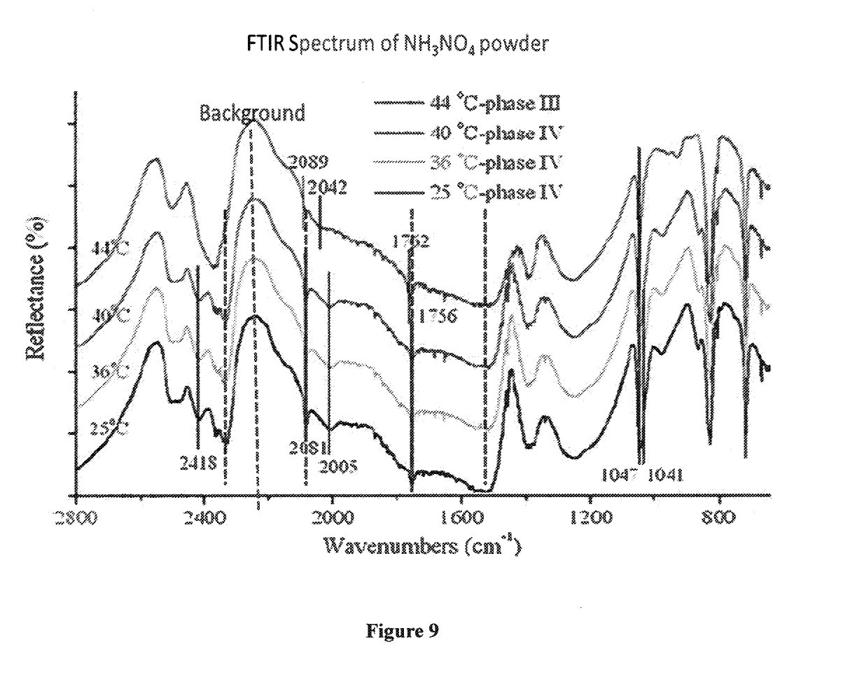

FIG. 9 shows the FTIR reflectance spectra of ammonium nitrate (NH₃NO₄) powder at temperatures from 25° C. to 44° C. Ammonium nitrate undergoes a phase change from phase IV at 25° C. to phase III at 44° C. The phase change is accompanied by shifts in the spectral features and changes in the amplitudes of certain spectral features. Dips in the reflection spectra represent absorption by ammonium nitrate. For example, weak reflection and correspondingly strong absorption that may be used to measure ammonium nitrate appear at frequencies of 2418 cm⁻¹, 2081-2089 cm⁻¹, 2005 cm⁻¹, 1756-1762 cm⁻¹, and 1041-1047 cm⁻¹. The relative constant spectral feature around 1550 cm⁻¹ may be used for the reference or background signal.

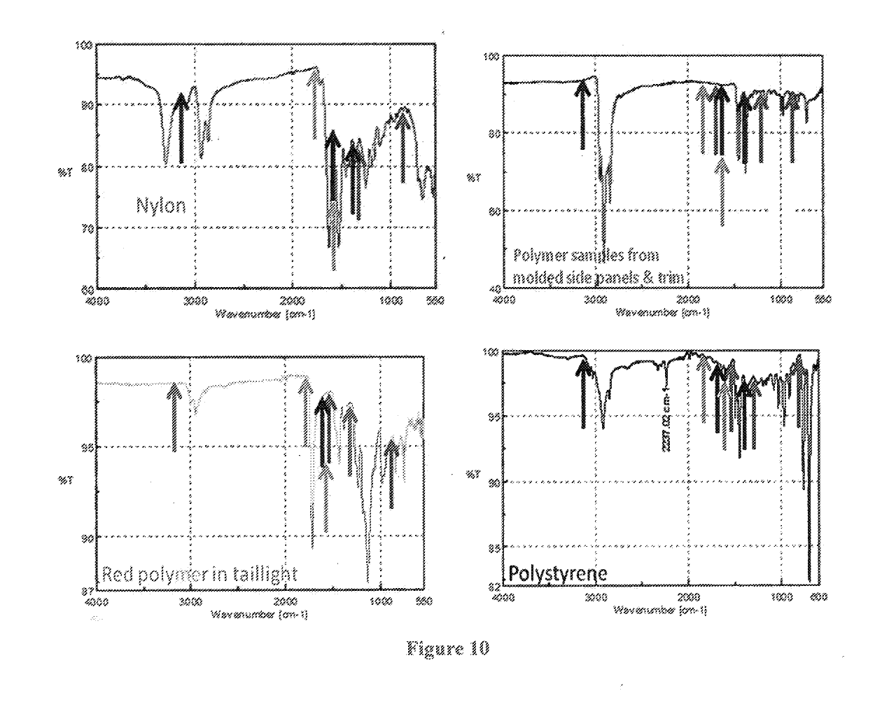

FTIR transmission spectra for nylon, automotive side-panel polymer, an automotive taillight polymer, and polystyrene are shown in FIGS. 10A, 10B, 10C, and 10D, respectively. The arrows show laser wavelengths at which the target analyte is strongly absorbed but at which the substrate does not strongly absorb.

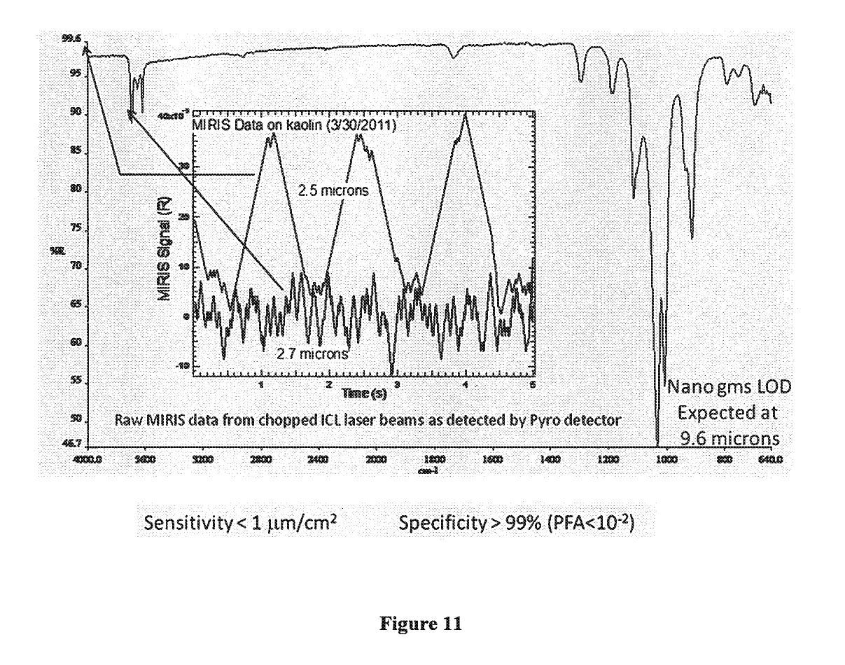

Another example of using irradiation at selected wavelengths to measure the amount of material on a surface is presented in FIG. 11. FIG. 11 shows an FTIR reflectance spectrum for the mineral kaolin. Kaolin exhibits strong reflection around 3,600 cm⁻¹ and around 1,000 cm⁻¹. The reflectance of chopped ICL laser radiation at 2.5 μm and at 2.7 μm is shown in the inset, wherein 2.5 μm corresponds to a region of the kaolin mid-IR spectrum showing little absorption (strong reflection) and 2.7 μm corresponds to a region of the kaolin mid-IR spectrum showing strong absorption (relatively weak reflection). The difference in the amplitude of the spectra can be used to measure the amount of kaolin on a surface. It is estimated that the sensitivity for the detection of kaolin using these two wavelengths is less than 1 μm/cm² and the specificity is greater than 99% (PFA<10⁻²).

Hyperspectral images of an area of a surface are obtained by irradiating the area at individual wavelengths and obtaining an image at each wavelength. The wavelength specific images may then be operated on to measure a particular analyte of interest. The hyperspectral images may be compared with a library spectra to measure one or more materials of interest. Hyperspectral image analysis methods are known in the art. Commercially available image analysis software packages such as ENVI (ITT Visual Information Systems) may be used to extract the images at different wavelengths using filters.

The results of hyperspectral image analysis may be reported in a number of ways. For example, the presence of an analyte and/or the amount of an analyte about a reestablished threshold may be reported as a visual and/or audio cue. Hyperspectral image analysis may also be reported as a spectral image, which may be superimposed on a visual image of the sample. The spectral image may be color-coded to represent the presence of one or more analytes. Visual or audio cues may be used to identify a sample for further comprehensive hyperspectral image analysis.

The optically multiplexed mid-IR laser systems provided by the present disclosure may be used for the detection and measurement of materials on surfaces. Detection refers to determination of the presence of a material on a surface. Measurement refers to quantification of the amount of a material on a surface.

In certain embodiments, a material or analyte of interest may be an explosive, a fuel source for an explosive, or may be a hazardous material. Examples of explosives include acetone peroxide, ammonium permanganate, azo-clathrates, copper acetylide, diazodinitrophenol, hexamethylene triperoxide diamine, lead azide, lead styphnate, lead pciarate, mercury(II) fulminate, nitrogen trichloride, nitrogen triiodide, nitroglycerin, silver azide, silver acetylide, silver fulminate, sodium azide, tetracene, tetraamine copper complexes, tetrazoles, trinitrotoluene (TNT), cyclotrimethylene nitramine (RDX), and ammonium nitrate (ANFO). Examples of fuel sources for explosives include nitromethane and pentaerythritol tetranitrate (PETN). A hazardous material may be any material that may cause harm to people, property, and/or the environment. A hazardous material may be subject to chemical regulations and may include radioactive materials; flammable materials such as nitrocellulose, magnesium, aluminum alkyls, white phosphorous, sodium, calcium, potassium, calcium carbide, and fuel residue; explosives; corrosive materials such as sulfuric acid, hydrochloric acid, potassium hydroxide, and sodium hydroxide; oxidizing agents such as calcium hypochlorite, ammonium nitrate, hydrogen peroxide, potassium permanganate, benzoyl peroxides, and cumene hydroperoxide; asphyxiants; biohazards; pathogens; and allergens; and toxins such as potassium cyanide, mercuric chloride, pesticides and methylene chloride.

Optically multiplexed mid-IR laser systems provided by the present disclosure may be used for the detection or measurement of materials on any surfaces. In certain embodiments, the optical systems may be used for security screening such as at airport entrances, building entrances, and transportation depots. The optical systems may be used for the detection of measurement of materials on any surface. For example, in certain applications a surface may include skin, hair, clothing, personal accessories, and luggage. Luggage may include plastic, metal, and/or fabric. In certain embodiments, a surface includes any structural surface such as metal, wood, and plastic. In certain embodiments, optical systems provided by the present disclosure may be used to detect and/or measure hazardous materials in the outdoor environment. In these applications, in addition to detecting and/or measuring hazardous materials on a person or structure, a surface may include sand, soil, gravel, stone, concrete, asphalt, and a combination of any of the foregoing.

In certain embodiments, an optical system provided by the present disclosure may be incorporated into a stationary apparatus such as an airport screening system or a remote sensing system. In certain embodiments, an optical system may be incorporated into a system designed to be transported such as mounted on a vehicle. In certain embodiments, an optical system provided by the present disclosure may be incorporated into a portable device, such as carried by an individual, and may be a handheld device. Stationary systems may be appropriate for security applications such as airport or building security screening systems. Portable sensing devices may be useful for stand-off detection of materials of interest such as in military operational, surveillance, or reconnaissance. It will be appreciated, that using appropriate design and integration techniques the physical size of the optically multiplexed mid-IR laser systems provided by the present disclosure may be adapted to accommodate the physical and operational requirements of a particular application.

In certain embodiments of standoff detection, optical systems provided by the present disclosure may be used to detect an amount of a material on a surface ranging from about 1 g/cm² to about 1 mg/cm² from about 1 mg/cm² to about 100 μg/cm² and in certain embodiments, from about 100 μg/cm² to about 10 μg/cm². In certain embodiments, optical systems provided by the present disclosure may be used to detect an amount of a material on a surface less than about 1 mg/cm² less than about 100 m/cm², and in certain embodiments, less than about 10 μg/cm².

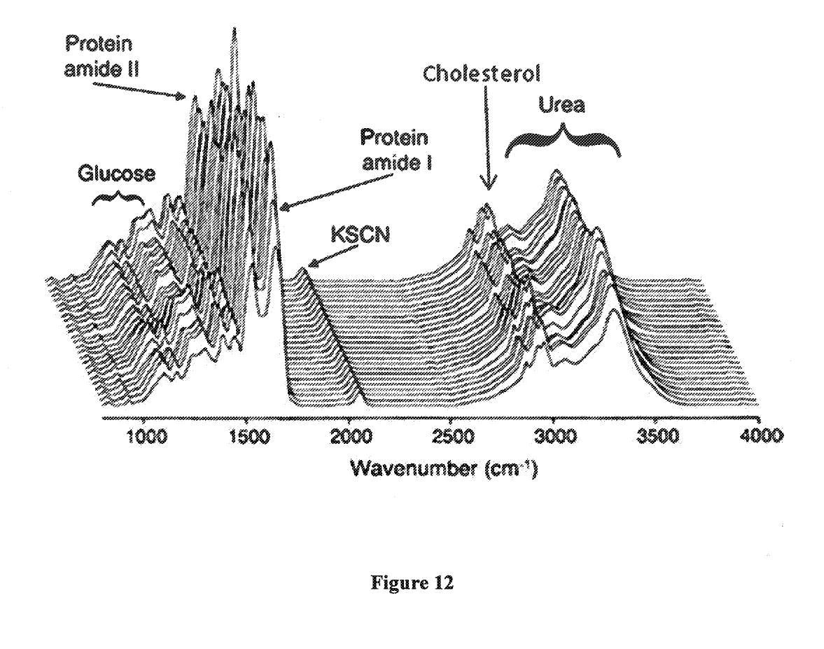

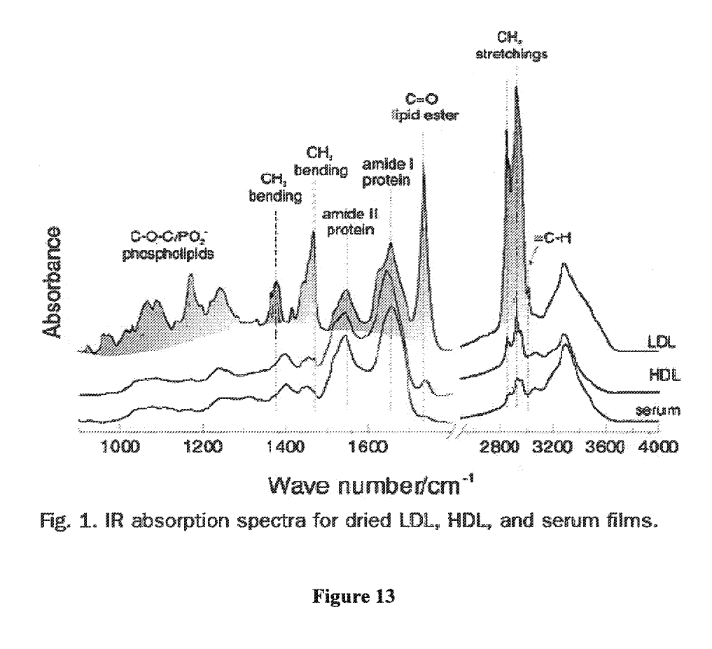

In certain embodiments, optically multiplexed systems provided by the presented by the present disclosure may be used in many applications in medical diagnostics. For example, FIG. 12 (from Low-Ying et al., Vibrational Spectroscopy 2002, 28, 111-116) shows twenty-five FTIR absorption spectra of dried whole blood films that have been normalized for the absorption of a known amount of KSCN added to each sample. The spectra demonstrate that certain blood constituents including glucose, protein amide II, protein amide I, cholesterol and urea exhibit strong mid-IR absorptions that can be used for quantitative analysis. Quantitative analysis of one of the analytes may be accomplished, for example, by measuring the absorbance of reflectance at a wavelength at which the analyte absorbs, and a wavelength at which the dried blood sample shows little absorption such as around 2250 cm⁻¹ or 3800 cm¹. As shown in FIG. 13, similarly differentiable mid-IR absorption is exhibited by low-density lipoprotein (LDL) and high-density lipoprotein (HDL), and are distinguishable in films of blood serum.

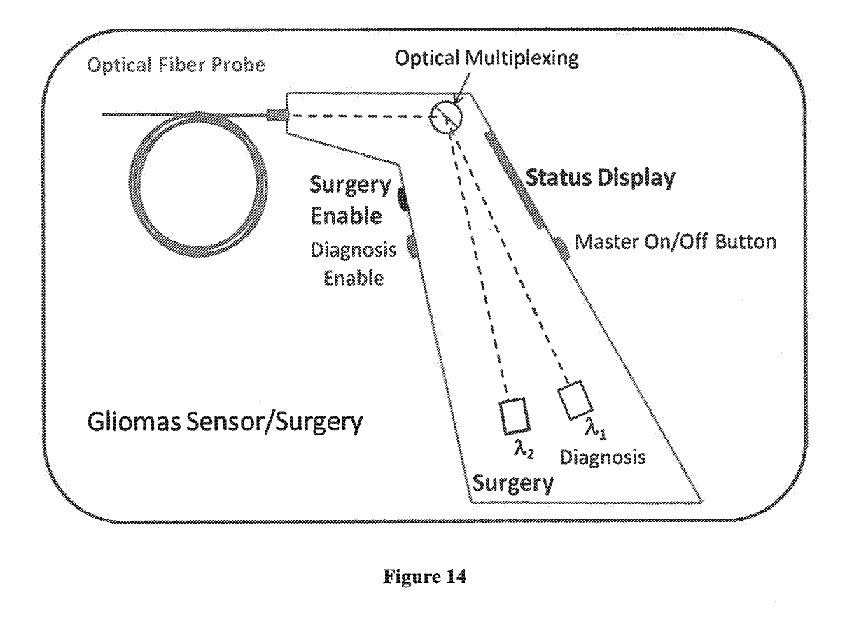

In certain embodiments for use in surgical applications, optically multiplexed systems provided by the present disclosure may be incorporated in to a surgical device. An example of a combined surgical and mid-IR imaging device is shown in the schematic of FIG. 14. Use of such a device could enable a surgeon to simultaneously or alternately image tissue in the mid-IR, image tissue in the visible, and diagnose tissue areas that are diseased and perform surgery. In this manner, mid-IR spectroscopy could be used to distinguish between diseased tissue such as cancerous tissues and normal tissue in situ and in real-time.

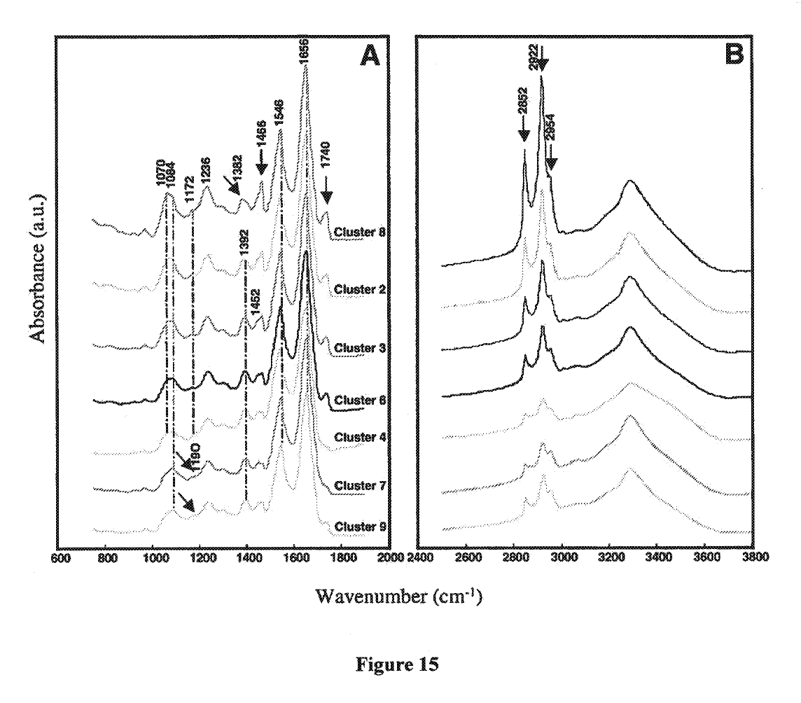

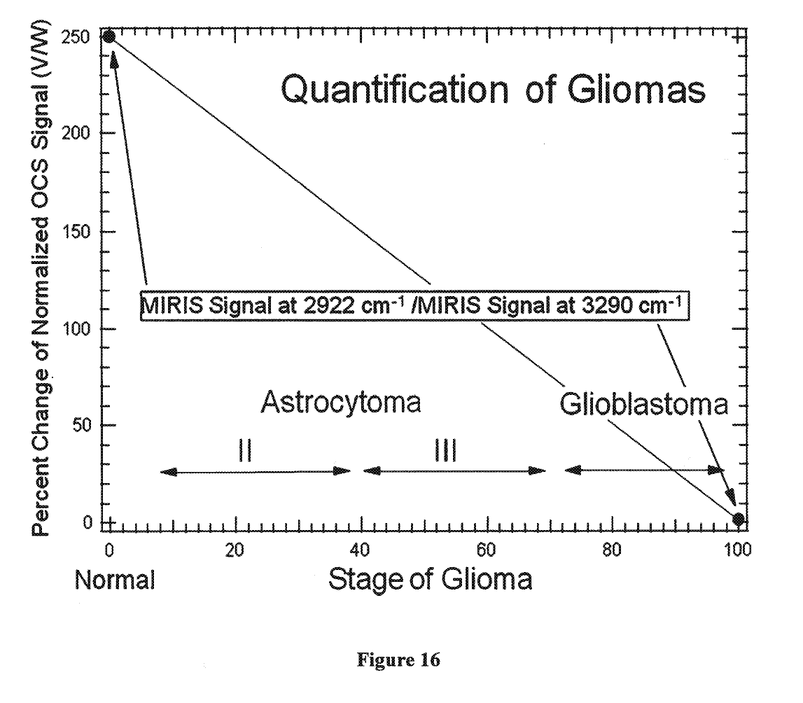

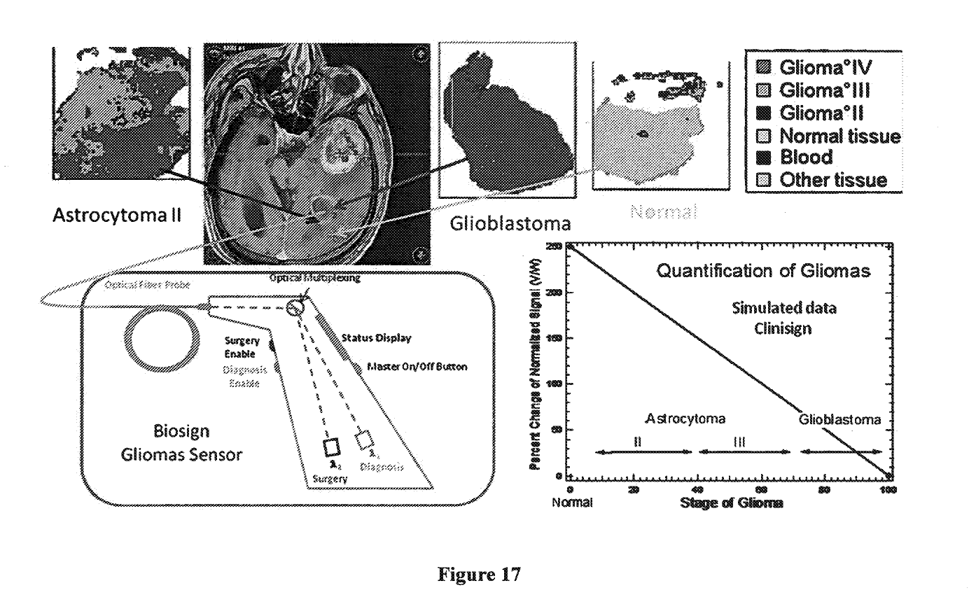

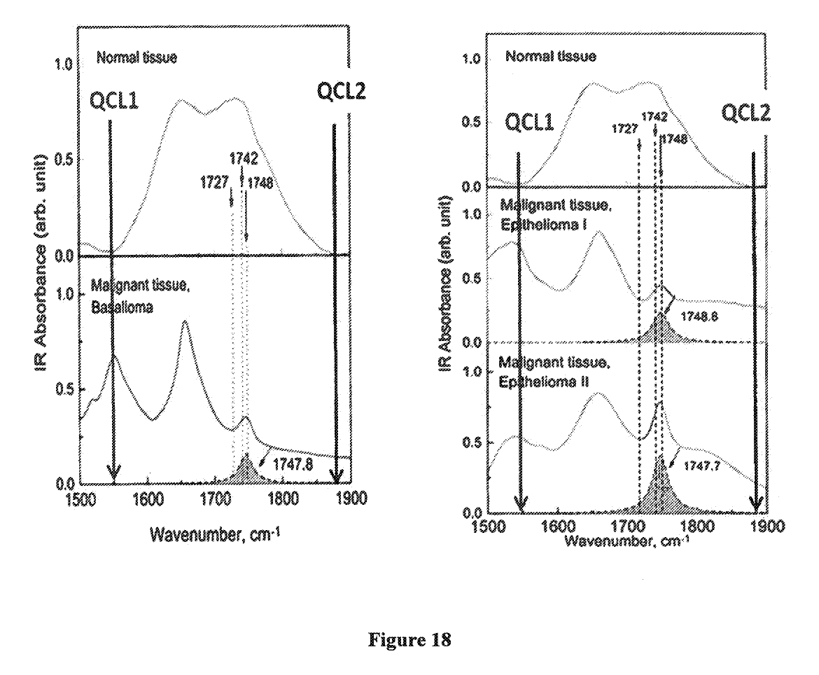

Such devices may be particularly useful for use in cancer surgery where there are significant different in the mid-IR spectra between cancerous and healthy tissue. For example, as shown in FIG. 15 shows there are significant differences in the FTIR spectra of glioma in rat (bottom) and healthy tissue (top) (from Amharref et al., Biochimica et Biophysica Acta 2006, 1758, 892-899). The mid-IR spectra exhibit difference as the glioma progresses in malignancy. Healthy tissue is shown at the top and malignant glioma at the bottom. For example, when compared with healthy tissue, the malignant tissue displayed a decreased intensity of the asymmetric PO₂⁻ (1236 cm⁻¹) band and of the C—C stretching (1070 cm⁻¹) band, an increased intensity of the symmetric PO₂⁻ (1084 cm⁻¹) band, and change in the shape of these bands. Disease progression may be tracked, using, for example, the difference in the absorbances at 2922 cm⁻¹ and 3290 cm⁻¹ as shown in FIG. 16 in which the simulated normalized absorbance difference is plotted. As illustrated, the difference signal may be used to characterize the type of glioma (astrocytoma II, astrocytoma III, and gliobalstoma) and to differentiate the gliomas from healthy tissue. To further exemplify the method, images of a surgical device, visual cross-section of a brain showing regions of astrocytoma II, glioblastoma, and normal tissue (from Sobottka et al., Anal Bioanal Chem 2009, 393, 187-195) and the simulated mid-IR difference in the absorbances at 2922 cm⁻¹ and 3290 cm⁻¹ are combined in FIG. 17. It can be appreciated that using a device incorporating a multiplexed optical system provided by the present disclosure could provide real-time pathology. Clear differences in the FTIR spectra from 1500 cm⁻¹ to 1900 cm⁻¹ are also evident between normal and neoplastic human skin tissue as shown in FIG. 18 (from Crupi et al., J. Mol. Structure, 2001, 563-564, 115-118). FIG. 18 shows the FTIR absorbance spectra of normal tissue, malignant basalioma tissue, and two types of malignant epithelioma II tissue. It can be appreciated that one or more spectral features may be used to distinguish normal from malignant human skin. For example, irradiation at the wavenumbers indicted by QCL1 and QCL2 could be used to distinguish cancerous tissue.

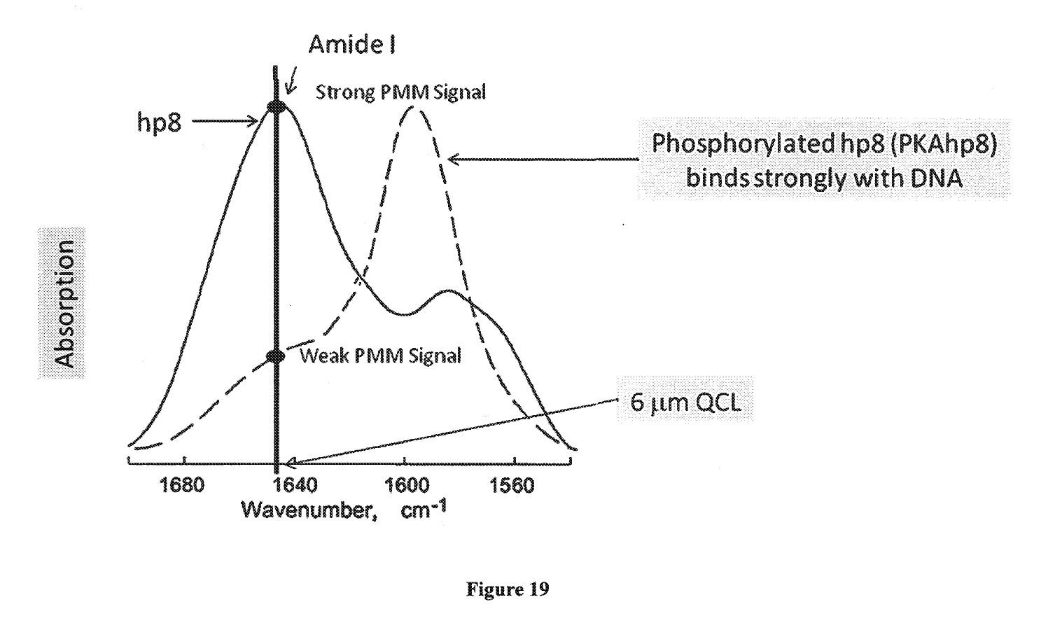

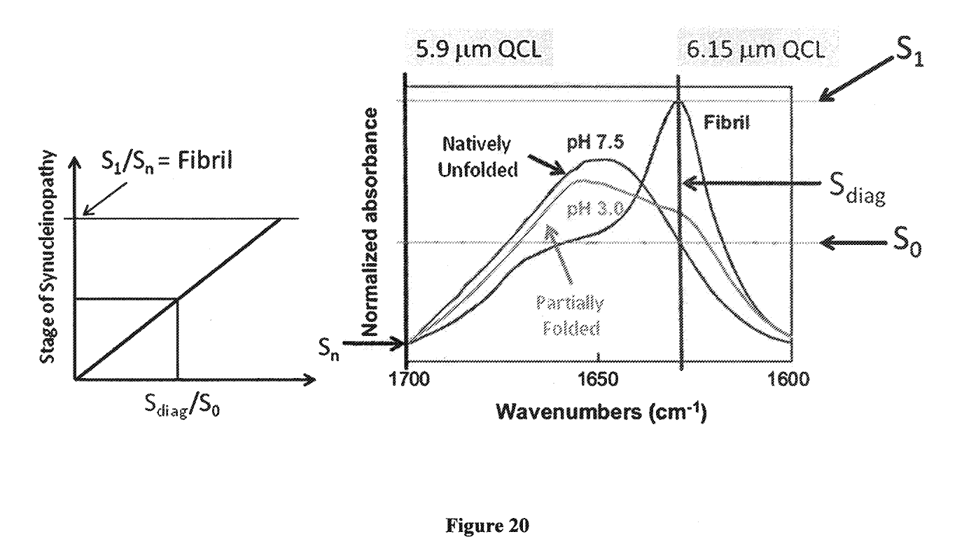

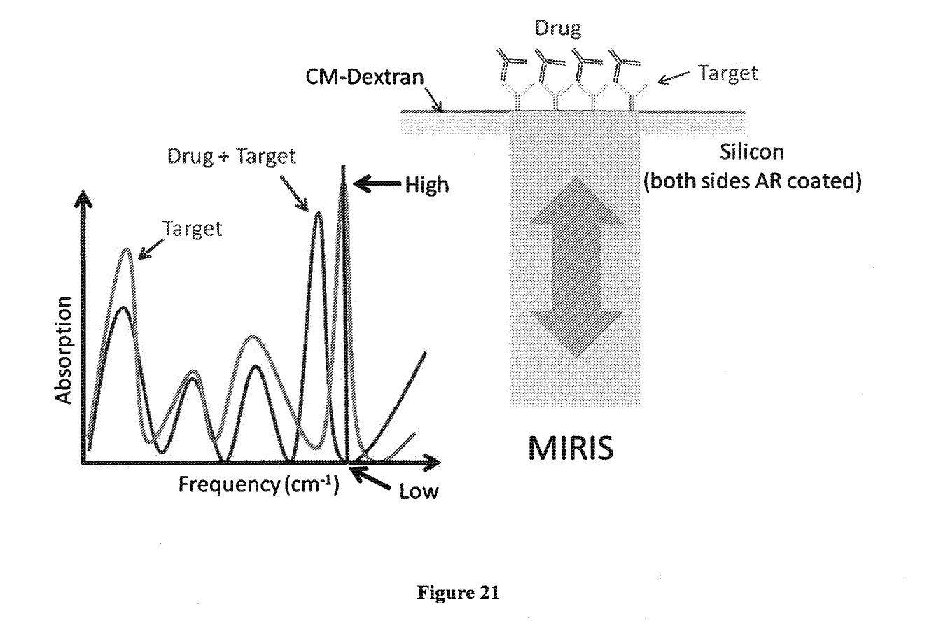

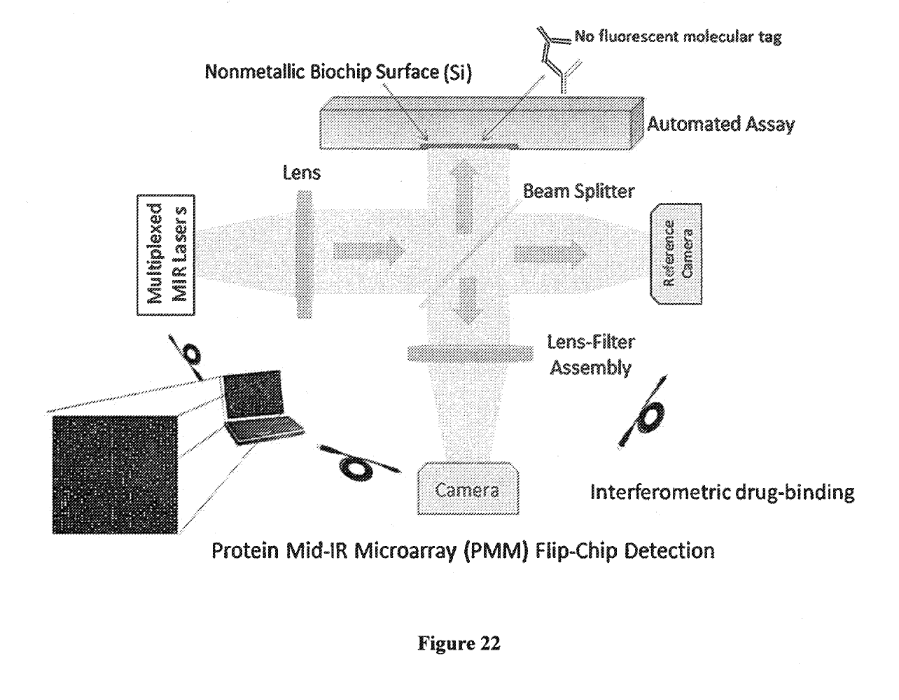

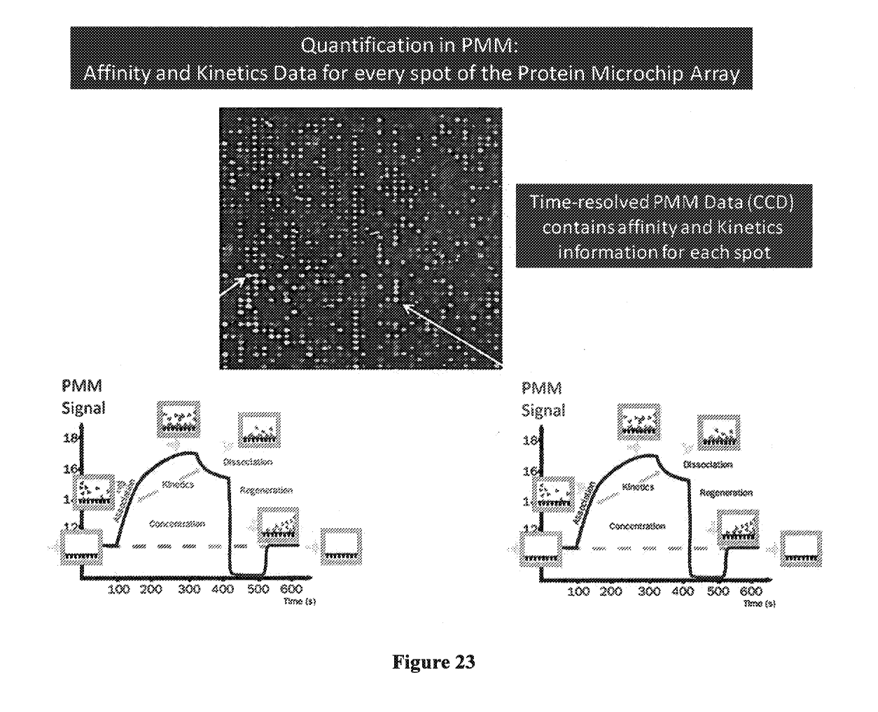

Optically multiplexed mid-IR systems provided by the present disclosure may also be used in high-throughput screening applications in molecular biology, chemistry, medicine, and pharmacology. FIG. 19 shows the dramatic differences in the FTIR spectra of human p8 (hp8), a nucleoprotein expressed in acute pancreatitis, upon phosphorylation (from Encinar et al., J. Biological Chemistry 2001, 276(4), 2742-2751). Measurement of the mid-IR absorption at 1640 cm⁻¹ can be used to monitor phosphorylation of hp8. The protein conformation of fibrillary aggregates of the α-synuclein protein in the cytoplasm is implicated in synucleinopathies including Parkinson's disease, dementia Alzheimer's disease, Down's syndrome, and multiple system atrophy. Differences in the mid-IR spectra of the fibril conformation are shown in FIG. 20 (from Uversky et al., Annual Review of Biophysics, 2008, 37, 215-246). As shown in FIG. 20, radiation at 1700 cm⁻¹ (5.9 μm) and 1625 cm⁻¹ (6.15 μm) can be used to establish the conformation of fibrils. FIG. 21 is a schematic diagram of an example of using mid-IR spectroscopy to measure drug-target binding in a microarray. Mid-IR absorption or reflectance spectra can be used to measure the binding of a drug to a target molecule as useful in drug discovery. Another configuration for high-throughput quantitative drug-target screening is shown in FIG. 22. In this system, optically multiplexed lasers image a microarray. As shown in FIG. 23, such systems may be used to obtain time-resolved affinity and kinetic information of biomolecular interactions.

Finally it should be noted that there are alternative ways of implementing the embodiments disclosed herein. Accordingly, the present embodiments are to be considered as illustrative and not restrictive, and the claims are not to be limited to the details given herein, but may be modified within the scope and equivalents thereof.

What is claimed is:

1. A system for imaging an area with radiation at a plurality of mid-infrared wavelengths, comprising:
a plurality of lasers, wherein each of the plurality of lasers emits radiation having a unique central wavelength from 2 μm to 20 μm;
an optical multiplexer for independently selecting the radiation emitted by the plurality of lasers;
a controller operably connected to the optical multiplexer for independently selecting the radiation;
optics for irradiating the area with the selected radiation; and
a detector for imaging the selected radiation reflected from the area.

2. The system of claim 1, wherein the selected radiation comprises:
radiation from a first laser with a central wavelength corresponding to a vibrational mode of an analyte; and
radiation from a second laser with a central wavelength that does not correspond to a vibrational mode of the analyte.

3. The system of claim 1, wherein the selected radiation comprises:
radiation from a first laser having a first central wavelength; and
radiation from a second laser having a second central wavelength;
wherein the first central wavelength and the second central wavelength are selected to identify the presence of an analyte of interest on the area.

4. The system of claim 1, wherein the selected radiation includes radiation having a wavelength corresponding to at least one vibrational mode a single analyte of interest.

5. The system of claim 1, wherein the selected radiation includes radiation having a central wavelength corresponding to at least one vibrational mode of more than one analyte of interest.

6. The system of claim 1, wherein at least one of the plurality of lasers emits radiation with a central wavelength corresponding to a vibrational mode of an analyte of interest.

7. The system of claim 1, wherein the plurality of lasers emits radiation with central wavelengths corresponding to vibrational modes of a plurality of analytes of interest.

8. The system of claim 13, comprising analyzing the images to determine the amount of an analyte present on the area of a surface.

9. The system of claim 1, wherein the plurality of lasers comprises a plurality of quantum cascade lasers.

10. The system of claim 1, wherein the plurality of lasers is 2 to 5 lasers.

11. The system of claim 1, wherein each the plurality of lasers is mounted on the same cooled substrate.

12. The system of claim 1, comprising a device for reducing laser speckle.

13. The system of claim 12, wherein the device for reducing laser speckle comprises a rotating and/or vibrating a hollow waveguide.

14. The system of claim 1, wherein the optical multiplexer comprises at least two blazed gratings, wherein each of the light beams has a different central wavelength.

15. The system of claim 1, wherein the optical multiplexer comprises:
a first blazed grating comprises a triangular blazed grating optimized for diffraction at 3.5 μm;
a second blazed grating comprises a triangular blazed grating optimized for diffraction at 7 μm; and
a third blazed grating comprises a triangular blazed grating optimized for diffraction at 13 μm.

16. The system of claim 15, wherein the optical multiplexer comprises:
a first dichroic beamsplitter configured to combine the beams diffracted from the first blazed grating and the second blazed grating to provide a first collinear beam; and
a second dichroic beamsplitter configured to combine the beams diffracted from the third blazed grating and the first collinear beam.

17. The system of claim 15, wherein the optical multiplexer comprises optics for compensating for wavelength dispersion for the beams diffracted from each of the blazed gratings.

18. The system of claim 17, wherein the optics comprises:
a hemispherical lens for focusing the diffracted beams into an optical fiber;
an optical fiber; and
a collimating lens.

19. A method of quantifying an amount of an analyte on an area, comprising:
irradiating the area with radiation emitted by a first laser having a first wavelength from 2 μm to 20 μm and corresponding to a vibrational mode of the analyte;
detecting the radiation emitted by the first laser that is reflected from the area;
irradiating the area with radiation emitted by a second laser having a second wavelength from 2 μm to 20 μm and that does not correspond to a vibrational mode of the analyte;
detecting the radiation emitted by the second laser that is reflected from the area; and
operating on the detected radiation emitted by the first laser and the detected radiation emitted by the second laser to quantify the amount of the analyte on the area.

20. A method of quantifying an amount of each of a plurality of analytes on an area, comprising:
independently irradiating the area with radiation emitted by a plurality of lasers, each of the plurality of lasers having a unique wavelength from 2 μm to 20 μm, wherein:
at least one of the wavelengths corresponds to a vibrational mode of each of the plurality of analytes; and
at least one of the wavelengths does not correspond to any vibrational mode of the plurality of analytes;
independently detecting the radiation emitted by each of the plurality of lasers that is reflected from the area; and
operating on the detected radiation to quantify the amount of each of the plurality of analytes on the area.
